(19) United States
(12) Patent Application Publication
(10) Pub. No.: US 2025/0330798 A1
(43) Pub. Date: Oct. 23, 2025

(54) DYNAMIC RESOURCE ALLOCATION BASED ON NETWORK CONFIGURATION

(71) Applicant: QUALCOMM Incorporated, San Diego, CA (US)

(72) Inventors: Akash KUMAR, Hyderabad (IN); Eswar Venkata Narasimha Muthyala Prasad BAHADURSHA, Hyderabad (IN); Dheeraj Kumar ENGALA, Rangareddy (IN)

(21) Appl. No.: 18/643,203

(22) Filed: Apr. 23, 2024

(51) Int. Cl. H04W 8/20; H04W 76/27

(52) U.S. Cl. CPC H04W 8/20; H04W 76/27

(57) ABSTRACT

A user equipment (UE) may receive radio resource control (RRC) signaling including a set of parameters for wireless communications with one or more network entities associated with a set of carriers in a carrier aggregation mode, a set of subscriptions at the UE in a multi-subscriber identify module (MSIM) mode, or both. The UE may receive control signaling including scheduling information for uplink or downlink signaling via the set of carriers, the set of subscriptions, or both. The UE may select a first radio frequency path of a set of radio frequency paths for a carrier of the set of carriers or a subscription of the set of subscriptions based on the set of parameters and the scheduling information. Each radio frequency path of the set of radio frequency paths may correspond to a respective set of radio frequency components.

### FIELD OF TECHNOLOGY

The following relates to wireless communications, including dynamic resource allocation based on network configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support dynamic resource allocation based on network configuration. For example, the described techniques provide for receiving, at a user equipment (UE), radio resource control (RRC) signaling including a set of parameters for wireless communications with one or more network entities associated with a set of carriers in a carrier aggregation mode, a set of subscriptions at the UE in a multi-subscriber identify module (MSIM) mode, or both. The UE may receive control signaling including scheduling information for uplink or downlink signaling via the set of carriers, the set of subscriptions, or both. The UE may select a first radio frequency path of a set of radio frequency paths for a carrier of the set of carriers or a subscription of the set of subscriptions based on the set of parameters and the scheduling information. Each radio frequency path of the set of radio frequency paths may correspond to a respective set of radio frequency components.

A method for wireless communications by a UE is described. The method may include receiving RRC signaling including a set of parameters for wireless communications with one or more network entities associated with a set of multiple carriers in a carrier aggregation mode, a set of multiple subscriptions at the UE in a MSIM mode, or both, receiving control signaling including scheduling information for uplink or downlink signaling via the set of multiple carriers, the set of multiple subscriptions, or both, and selecting a first radio frequency path of a set of radio frequency paths for a carrier of the set of multiple carriers or a subscription of the set of multiple subscriptions based on the set of parameters and the scheduling information, where each radio frequency path of the set of radio frequency paths corresponds to a respective set of radio frequency components.

A UE for wireless communications is described. The UE may include one or more memories storing processor executable code, and one or more processors coupled with the one or more memories. The one or more processors may individually or collectively be operable to execute the code to cause the UE to receive RRC signaling including a set of parameters for wireless communications with one or more network entities associated with a set of multiple carriers in a carrier aggregation mode, a set of multiple subscriptions at the UE in a MSIM mode, or both, receive control signaling including scheduling information for uplink or downlink signaling via the set of multiple carriers, the set of multiple subscriptions, or both, and select a first radio frequency path of a set of radio frequency paths for a carrier of the set of multiple carriers or a subscription of the set of multiple subscriptions based on the set of parameters and the scheduling information, where each radio frequency path of the set of radio frequency paths corresponds to a respective set of radio frequency components.

Another UE for wireless communications is described. The UE may include means for receiving RRC signaling including a set of parameters for wireless communications with one or more network entities associated with a set of multiple carriers in a carrier aggregation mode, a set of multiple subscriptions at the UE in a MSIM mode, or both, means for receiving control signaling including scheduling information for uplink or downlink signaling via the set of multiple carriers, the set of multiple subscriptions, or both, and means for selecting a first radio frequency path of a set of radio frequency paths for a carrier of the set of multiple carriers or a subscription of the set of multiple subscriptions based on the set of parameters and the scheduling information, where each radio frequency path of the set of radio frequency paths corresponds to a respective set of radio frequency components.

A non-transitory computer-readable medium storing code for wireless communications is described. The code may include instructions executable by one or more processors to receive RRC signaling including a set of parameters for wireless communications with one or more network entities associated with a set of multiple carriers in a carrier aggregation mode, a set of multiple subscriptions at the UE in a MSIM mode, or both, receive control signaling including scheduling information for uplink or downlink signaling via the set of multiple carriers, the set of multiple subscriptions, or both, and select a first radio frequency path of a set of radio frequency paths for a carrier of the set of multiple carriers or a subscription of the set of multiple subscriptions based on the set of parameters and the scheduling information, where each radio frequency path of the set of radio frequency paths corresponds to a respective set of radio frequency components.

Some examples of the method, UEs, and non-transitory computer-readable medium described herein may further include operations, features, means, or instructions for performing one or more signal to noise ratio (SNR) measurements for the set of multiple carriers or the set of multiple subscriptions, where selecting the first radio frequency path may be based on the one or more SNR measurements, one or more entries in a modulation and coding scheme (MCS) table indicated by the RRC signaling, an MCS indicated by the control signaling for the uplink signaling, or any combination thereof.

In some examples of the method, UEs, and non-transitory computer-readable medium described herein, a first set of radio frequency components of the first radio frequency path includes a first power amplifier (PA) corresponding to a first threshold transmit power for the uplink signaling, and a second set of radio frequency components of a second radio frequency path includes a second PA corresponding to a second threshold transmit power for the uplink signaling.

Some examples of the method, UEs, and non-transitory computer-readable medium described herein may further include operations, features, means, or instructions for identifying a threshold operating power level based on the RRC signaling and calculating an average transmit power based on the control signaling for the uplink signaling, where selecting the first radio frequency path may be based on the threshold operating power level, the average transmit power, or both.

Some examples of the method, UEs, and non-transitory computer-readable medium described herein may further include operations, features, means, or instructions for calculating an average quantity of resource blocks (RBs) allocated by the control signaling, where selecting the first radio frequency path may be based on the average quantity of RBs, and where a first set of radio frequency components of the first radio frequency path includes a first PA corresponding to a first threshold efficiency level for the uplink signaling, and where a second set of radio frequency components of a second radio frequency path includes a second PA corresponding to a second threshold efficiency level for the uplink signaling.

Some examples of the method, UEs, and non-transitory computer-readable medium described herein may further include operations, features, means, or instructions for detecting one or more transition scenarios pending based on the RRC signaling, the scheduling information for the uplink or downlink signaling, or both, where selecting the first radio frequency path may be based on the one or more transition scenarios.

In some examples of the method, UEs, and non-transitory computer-readable medium described herein, the one or more transition scenarios include a transition between the uplink signaling and the downlink signaling, an antenna switching procedure, a carrier switching procedure, a channel switching procedure, an uplink timing advance, a downlink to uplink gap according to a guard symbol, a power switching procedure, or any combination thereof.

In some examples of the method, UEs, and non-transitory computer-readable medium described herein, to selecting the first radio frequency path may include operations, features, means, or instructions for selecting the first radio frequency path of the set of radio frequency paths for the carrier of the set of multiple carriers or the subscription of the set of multiple subscriptions based on a mobility state at the UE.

Some examples of the method, UEs, and non-transitory computer-readable medium described herein may further include operations, features, means, or instructions for switching from a current radio frequency path associated with the carrier of the set of multiple carriers or the subscription of the set of multiple subscriptions to the first radio frequency path based on the selecting.

Some examples of the method, UEs, and non-transitory computer-readable medium described herein may further include operations, features, means, or instructions for performing a blanking procedure associated a delay in switching from the current radio frequency path to the first radio frequency path at the UE.

Some examples of the method, UEs, and non-transitory computer-readable medium described herein may further include operations, features, means, or instructions for inputting the set of parameters, the scheduling information, or both, into a machine learning (ML) model associated with the set of radio frequency paths for communicating at the UE, where selecting the first radio frequency path may be based on an output of the ML model.

Some examples of the method, UEs, and non-transitory computer-readable medium described herein may further include operations, features, means, or instructions for selecting the first radio frequency path of the set of radio frequency paths for the carrier of the set of multiple carriers or the subscription of the set of multiple subscriptions may be based on co-existence interference associated with a transmit antenna and a receive antenna at the UE.

Some examples of the method, UEs, and non-transitory computer-readable medium described herein may further include operations, features, means, or instructions for selecting the first radio frequency path of the set of radio frequency paths for the carrier of the set of multiple carriers or the subscription of the set of multiple subscriptions based on an application type associated with the uplink or downlink signaling.

### BRIEF DESCRIPTION OF THE DRAWINGS

FIG. 1 shows an example of a wireless communications system that supports dynamic resource allocation based on network configuration in accordance with one or more aspects of the present disclosure.

FIG. 2 shows an example of a wireless communications system that supports dynamic resource allocation based on network configuration in accordance with one or more aspects of the present disclosure.

FIG. 3 shows an example of a process flow that supports dynamic resource allocation based on network configuration in accordance with one or more aspects of the present disclosure.

FIGS. 4 and 5 show block diagrams of devices that support dynamic resource allocation based on network configuration in accordance with one or more aspects of the present disclosure.

FIG. 6 shows a block diagram of a communications manager that supports dynamic resource allocation based on network configuration in accordance with one or more aspects of the present disclosure.

FIG. 7 shows a diagram of a system including a device that supports dynamic resource allocation based on network configuration in accordance with one or more aspects of the present disclosure.

FIGS. 8 through 10 show flowcharts illustrating methods that support dynamic resource allocation based on network configuration in accordance with one or more aspects of the present disclosure.

### DETAILED DESCRIPTION

In some wireless communications systems, some user equipments (UEs) may perform uplink and downlink signaling via different radio frequency paths (e.g., transmit chains or receive chains) made up of different components (e.g., power amplifiers (PAs), phase shifters, filters, antennas or antenna configurations, among other examples). In some examples, the components of different radio frequency paths may not be equivalent (e.g., one path may include a high efficiency PA or a PA supporting higher transmit power, than a PA in another path). In some cases, all radio frequency paths may be assigned by the UE offline. That is, the assignments may be based on rigid rules. In some cases, the rigid rules may cause a higher performing radio path to be assigned to simple or low complexity signaling (e.g., inefficiently utilize high cost or high performance components on simplistic signaling), or lower performing radio paths may be assigned to high priority or high complexity signaling that may be beyond the capability of the lower performing components of the lower performing radio path (e.g., resulting in failed transmission or reception, increased latency, poor reliability, etc.).

According to techniques described herein, a UE may utilize available information to determine both long-term configuration information and dynamic scheduling information to determine which radio path should be assigned to signaling (e.g., for a carrier in a carrier aggregation deployment, or subscription in an multi-subscriber identify module (MSIM) scenario). For example, the UE may receive radio resource control (RRC) signaling indicating configuration information, and control signaling (e.g., downlink control information (DCI) signaling) scheduling uplink or downlink signaling. The RRC signaling and the DCI signaling may be utilized to determine a more complete or accurate picture of needs for scheduled signaling based on real-time information, as well as average or long-term information about the signaling and configuration over time. The UE may determine which radio frequency path to assign to which signaling procedures based on the information about the signaling. In some cases, the UE may input the information gathered from the RRC signaling and the DCI signaling into an machine learning (ML) model, and an output of the ML model may indicate which radio frequency path to apply in various situations. The UE may select a radio frequency path based on the RRC signaling, the DCI signaling, the output of the ML model, modulation and coding scheme (MCS) configurations, average resource blocks (RBs) assigned over time, PA capabilities, switching times, transition time limitations, co-existence interference, or application type. For example, the UE may select one of various radio frequency components or radio frequency paths for use for the uplink or downlink signaling.

Aspects of the disclosure are initially described in the context of wireless communications systems. Aspects of the disclosure are further illustrated by and described herein with reference to apparatus diagrams, system diagrams, and flowcharts that relate to dynamic resource allocation based on network configuration.

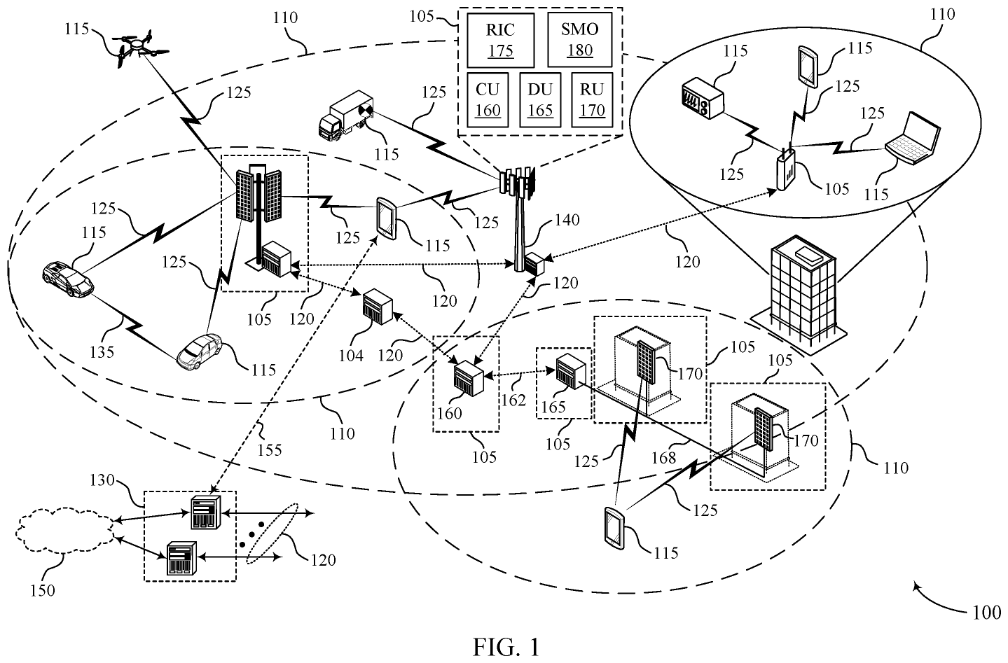

FIG. 1 shows an example of a wireless communications system 100 that supports dynamic resource allocation based on network configuration in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

According to techniques described herein, a UE 115 may utilize available information to determine both long-term configuration information and dynamic scheduling information to determine which radio path should be assigned to signaling (e.g., for a carrier in a carrier aggregation deployment, or subscription in a MSIM scenario). For example, the UE 115 may receive RRC signaling indicating configuration information, and control signaling (e.g., DCI signaling) scheduling uplink or downlink signaling. The RRC signaling and the DCI signaling may be utilized to determine a more complete or accurate picture of needs for scheduled signaling based on real-time information, as well as average or long-term information about the signaling and configuration over time. The UE 115 may determine which radio frequency path to assign to which signaling procedures based on the information about the signaling. In some cases, the UE 115 may input the information gathered from the RRC signaling and the DCI signaling into an ML model, and an output of the ML model may indicate which radio frequency path to apply in various situations. The UE 115 may select a radio frequency path based on the RRC signaling, the DCI signaling, the output of the ML model, MCS configurations, average RBs assigned over time, PA capabilities, switching times, or transition time limitations. For example, the UE 115 may select one of various radio frequency components or radio frequency paths for use for the uplink or downlink signaling.

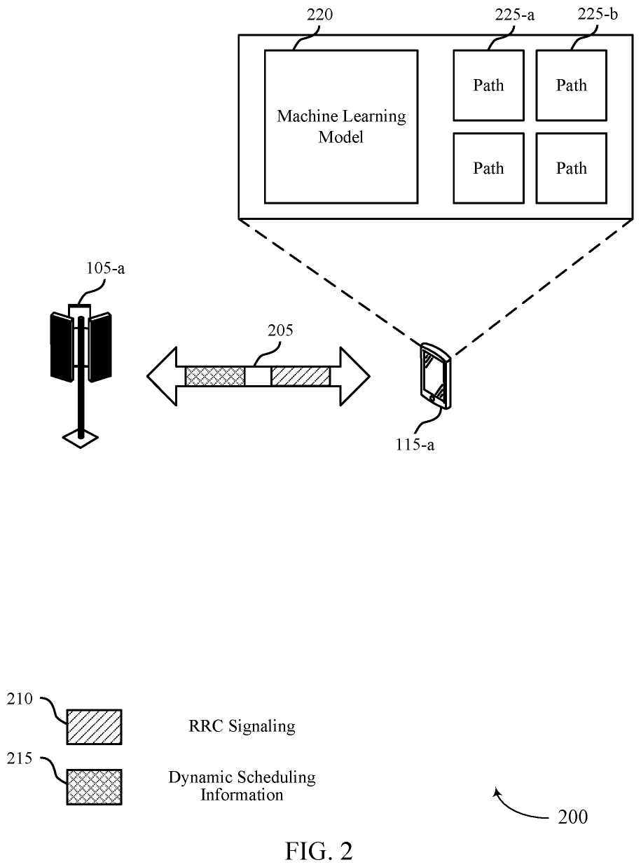

FIG. 2 shows an example of a wireless communications system 200 that supports dynamic resource allocation based on network configuration in accordance with one or more aspects of the present disclosure. In some examples, wireless communications system 200 may implement aspects of wireless communications system 100. For example, a UE 115-a may represent an example of a UE, such as the UEs 115 described herein with reference to FIG. 1. The network entity 105-a may represent an example of a network entity, such as the network entity 105 described herein with reference to FIG. 1. The UE 115-a may include a ML model 220 and a set of radio frequency paths 225 (e.g., which may be referred to as radio frequency paths, radio paths, receive or transmit chains, sets of radio frequency components, or signal paths, among other examples). The radio frequency paths 225 may include PAs, phase shifters, filters, or other components. The network entity 105-a and the UE 115-a may communicate via a communications link 205. As described herein, the UE 115-a may select radio frequency paths 225 for signaling (e.g., uplink or downlink signaling) based on RRC signaling 210 (e.g., long-term configuration information) and dynamic scheduling information 215 (e.g., DCI signaling scheduling uplink and downlink signaling), which may support selection of radio frequency paths 225 for scheduled signaling, resulting in increased communications reliability. The UE 115-a may receive RRC signaling 210 from the network entity 105-a, and the UE 115-a may receive dynamic scheduling information 215 from the network entity 105-a. The RRC signaling 210 may indicate RRC configuration information.

In some wireless communications systems, a UE 115-a may support multiple radio and modem features associated with varying modem and radio envelopes. For example, the UE 115-a may support uplink carrier aggregation (ULCA), downlink carrier aggregation (DLCA), or dual connectivity multi-subscriber identity module (MSIM) (e.g., dual-receive dual SIM dual standby (DR-DSDS) or dual SIM dual active (DSDA)). That is, the UE 115-a may communicate with one or more network entities 105 associated with a set of carriers in a carrier aggregation mode or a set of subscriptions at the UE 115-a in an MSIM mode.

The UE 115-a may support multiple modem or radio transmitter and receiver paths (e.g., radio frequency paths 225). For example, the UE 115-a may support wireless communications (e.g., uplink signaling, downlink signaling, sidelink signaling, among other examples) via the radio frequency path 225-a and the radio frequency path 225-b. The UE 115-a may utilize the radio frequency paths 225 to internally receive and process signaling or to generate and transmit signaling. The radio frequency paths 225 may each include a set of components. In some examples, the different radio frequency paths 225 may include different components of varying capabilities (e.g., varying efficiency, complexity, etc.). The performance of the radio frequency paths 225 may vary (e.g., the radio frequency path 225-a may provide better performance than the radio frequency path 225-b for some signaling). In some cases, the performance associated with the radio frequency path 225-a may provide better performance than the radio frequency path 225-b based on superior components included in the radio frequency path 225-a compared to the radio frequency path 225-b (e.g., the radio frequency path 225-a may include a better PA or external low noise amplifier (LNA) than the radio frequency path 225-b).

In some examples, the UE 115-a may be built or configured with superior components on a subset of paths (e.g., a subset of radio frequency paths 225 including the radio frequency path 225-a) compared to others radio frequency paths (e.g., the radio frequency path 225-b). That is, the radio frequency path 225-a may provide better performance than the radio frequency path 225-b based on the respective components associated with each of the radio frequency paths 225.

In some cases, the radio frequency path 225-a may provide better performance than the radio frequency path 225-b based on the PAs associated with the radio frequency path 225-a and the radio frequency path 225-b having different capabilities (e.g., the PAs may support average power tracking (APT), envelope tracking (ET), or enhanced power tracking (EPT), and the PAs may have bandwidth dependencies). For example, the radio frequency path 225-b may include a PA that supports a basic APT, while the radio frequency path 225-a may include a PA that supports a more efficient and sophisticated ET. In some cases, the radio frequency path 225-a may provide better performance than the radio frequency path 225-b based on different PA, advanced sleep mode (ASM), or transmission switching or receive switching associated with the radio frequency paths 225 in the radio frequency front end (RFFE) having different transition and switching times. For example, the radio frequency path 225-a may be associated with a shorter transition and switching time compared to the radio frequency path 225-b based on the components included in the radio frequency paths 225. In some cases, the radio frequency path 225-a may provide better performance than the radio frequency path 225-b based on different antennas associated with the radio frequency path 225-a and the radio frequency path 225-b being placed on different sides of the UE 115-a. The different antennas may be associated with different insertion loss (IL) based on the varying trace length or losses. The varying trace length or losses may cause different uplink performance (e.g., error vector magnitude (EVM)) at the max power as a result of different PA linearity.

In some cases, the UE 115-a may select a radio frequency path for signaling based on a power headroom report (PHR) and a maximum transmit power level (MTPL). That is, opportunistic antenna switch diversity (ASDIV) may only consider PHR and MTPL which may be the same. Currently, the path assignment in different modes may be done statically (e.g., at compile time) with a fixed set of rules. For carrier aggregation, the UE 115-a may prioritize a primary component carrier (PCC) over a secondary component carrier (SCC). For MSIM the UE 115-a may prioritize a data subscription over a non-data subscription, or may prioritize a first subscription (Sub1) over a second subscription (SUB2). The fixed set of rules may be inefficient (e.g., suboptimal) where the superior capabilities of the superior path (e.g., radio frequency path 225-a) may not be utilized to the fullest based on the network configuration. That is, the radio frequency path 225-a may be assigned to lower priority and low complexity signaling, while higher priority and higher complexity signaling may be assigned to the radio frequency path 225-b. Without consideration of actual aspects of scheduled transmissions or configurations, radio frequency paths 225 may be assigned inefficiency, resulting in decreased performance and efficiency, failed transmissions, decreased reliability of wireless communications, increased system latency, and decreased user experience.

According to techniques described herein, the UE 115-a may perform a dynamic path allocation based on the received RRC signaling 210 (e.g., network configuration or RRC configuration) and the received dynamic scheduling information 215 (e.g., some dynamic scheduling parameters) to make sure that the hardware or radio frequency resource allocation is done efficiently (e.g., optimally) to suit the network configuration. The path allocation may improve the overall UE 115-a performance with no associated additional hardware cost.

The UE 115-a may check the received RRC configuration (e.g., the long-term configuration information) to infer the worst-case configuration that may get exercised across the carriers and subscriptions. The UE 115-a may check the actual scheduling (e.g., DCI scheduling) and configuration in steady state and infer other parameters or configuration in an average sense (e.g., the UE 115-a may determine what scheduling or parameters are being set up by a particular network over time and for specific scheduled transmissions). The UE 115-a may use the RRC configuration and the actual scheduling to determine information about a carrier aggregation or MSIM deployment. Additionally, or alternatively, the UE 115-a may use a ML model 220 or artificial intelligence (AI) model for ML-based data mining to get a sense of possible UE configuration in different deployments.

For example, the UE 115-a may derive long-term configuration and scheduling data based on the deployments of a network at a particular geo-location. That is, the UE 115-a may determine what configuration a network operators or specific carrier operators have deployed in a given geo-location. The UE 115-a may perform an offline data mining procedure for a given carrier operator, and the UE 115-a may determine what configuration or scheduling the given carrier operator has for the UEs 115 in the geo-location. In some cases, the UE 115-a may input one or more parameters derived from or indicated via the RRC configuration or scheduling information into the ML model 220. The UE 115-a may infer or estimate upcoming scheduling for the UE 115-a. Based thereon (e.g., or based on the output of the ML model) the UE 115-a may determine a more efficient and dynamic radio frequency path allocation scheme based on the RRC configuration, actual scheduling, or the data mining. That is, the UE 115-a may perform a dynamic radio frequency resource and radio frequency path assignment across different carriers (e.g., of a CA deployment), different subscriptions (e.g., in an MSIM scenario), or both. The UE 115-a may select a radio frequency path 225 for a given signaling, carrier, or subscription (e.g., SIM) based on the one or more parameters or scheduling information. For example, the UE 115-a may perform dynamic path allocation based on the one or more parameters or scheduling information. In some cases, the UE 115-a may select the radio frequency path 225 for a given signaling, carrier, or subscription based on the output of the ML model 220.

In some examples, the UE 115-a may perform internal blanking (e.g., one or two ms) time to perform an RF retuning procedure (e.g., to retune a transmitter or a receiver) at the UE 115-a based on the dynamic path allocation. The UE 115-a may perform internal blanking for switching from a current radio frequency path 225 to a selected radio frequency path 225. In other words, the UE 115-a may perform internal blanking for the radio frequency retuning associated with path assignment (e.g., with a suitable time hysteresis and algorithm such as a bail out algorithm to avoid any negative impact on the scheduled signaling).

The UE 115-a may perform dynamic path allocation based on a mobility state. For example, the UE 115-a may not perform or may limit dynamic path allocation based on the UE 115-a being in a high mobility state (e.g., a highly dynamic scenario). In such examples, if the mobility state of the UE 115-a satisfies a threshold (e.g., if the mobility state of the UE 115-a is too high or the UE 115-a is too mobile) then the UE 115-a may refrain from performing the dynamic path allocation (e.g., and may instead default to a set of baseline conditions or rules for allocating paths).

According to techniques described herein, the different radio frequency paths 225 may support different performance levels (e.g., linearity or EVM). That is, the UE 115-a may be associated with asymmetric path performance. In some examples, each radio frequency path 225 may support different PA performance based on usage of different PAs. For example, the radio frequency path 225-a may support better performance than the radio frequency path 225-b based on a first PA include in the radio frequency path 225-a having a greater capability than a second PA included in the radio frequency path 225-b. In some examples, each radio frequency path 225 may be associated with different IL due to varying trace length. The uplink performance at close to max power may be based on the IL and trace length. For example, the radio frequency path 225-a may be associated with a first transmit antenna at a first location in the UE 115-a and the radio frequency path 225-b may be associated with a second transmit antenna at a second location in the UE 115-a. A first IL associated with the radio frequency path 225-a may be based on a first trace length from a PA included in the radio frequency path 225-a to the first transmit antenna, and a second IL may be based on a second trace length from a PA included in the radio frequency path 225-b to the second transmit antenna. In some examples, each radio frequency path 225 may be associated with a different max power or a MTPL on different radio frequency paths 225 (e.g., power class (PC) 2 vs PC3). For example, the radio frequency path 225-a may be associated with a first max power and the radio frequency path 225-b may be associated with a second max power. The first max power may be larger than the second max power based on a respective PA associated with each radio frequency path 225 or a trace length associated with each radio frequency path 225.

The UE 115-a may perform dynamic path allocation based on the asymmetric path performance. The UE 115-a may check the network configuration (e.g., RRC configuration), and the UE 115-a may check the MCS table configured by the RRC configuration and actual MCS scheduled by the network entity for one or more transmissions. The UE 115-a may determine a MSC used by the network entity 105-a based on the configured MSC table and the actual MCS indicated in scheduling information. Additionally, or alternatively, the UE 115-a may check the SNR conditions of each configured carrier or subscription. The UE 115-a may determine a more efficient radio frequency path 225 based on the configured MCS table, the actual MCS scheduled, and the SNR conditions. For example, the UE 115-a may select a radio frequency path 225 that is sufficient for the configured MCS table, the actual MCS schedule, and the SNR conditions. That is, the UE 115-a may determine that the radio frequency path 225-b is sufficient for the given MCS and SNR conditions associated with first signaling. The UE 115-a may use the radio frequency path 225-a for second signaling associated with more demanding MCS and SNR conditions.

For example, a subscription or carrier configured with low MCS may not rely on a better uplink EVM performing radio frequency path 225, compared to a carrier or subscription scheduled at a peak MCS (e.g., which may rely on a higher performing EVM). In some examples, the operating average transmit power expected (e.g., as per a power control equation) on each subscription or carrier may be different at a given point of time. The dynamic path allocation may allocate a higher MTPL capable radio frequency path 225 or better performing radio frequency path 225 at max power to a suitable subscription or carrier based on a transmit limits (e.g., p-max or p-nr-frl) configured by the network (e.g., network entity 105-a) and the subscription or carrier operating close to max power.

In some cases, the radio frequency paths 225 may include different PAs which may support different capabilities. That is, the UE 115-a may support radio frequency paths 225 that support asymmetric PA behavior and characteristics. For example, some PAs may be power efficient (e.g., ET capable) while other PAs may be APT capable. For example, the radio frequency path 225-a may include a PA associated with increased efficiency, while the radio frequency path 225-b may include a PA associated with decreased hardware costs and decreased processing requirement. The different PAs may support different capabilities related to noise detection and reduction (NDR) and other UE features.

The UE 115-a may perform dynamic path allocation based on asymmetric PA behavior and characteristics. The UE 115-a may check the network configuration (e.g., RRC configuration), and the UE 115-a may check the configured network limits to infer the max possible operating power levels. The UE 115-a may check the current scheduling and operating conditions to infer the average transmit power. The UE 115-a may allocate the most power efficient radio frequency path 225 (e.g., ET path) to the carrier operating at a higher transmit power level. Additionally, or alternatively, the UE 115-a may allocate a radio frequency path 225 to the subscription or carrier capable of operating the NDR capable path more effectively (e.g., based on average RB allocations, some ET capable radio frequency paths 225 can be effectively operated in ET).

In some cases, the different radio frequency paths 225 may include other different RFFE components (e.g., transmission switching or receive switching or ASM). The different components may be reconfigured or programmed for different scenarios (e.g., uplink to downlink transitions or sounding reference signal (SRS) antenna or carrier switching). That is, the UE 115-a may be associated with asymmetric behavior of different RFFE components in the radio frequency path. The different components may be associated with different settling or transition times. That is, the different components may perform differently in a given transition scenario.

The UE 115-a may perform dynamic path allocation based on asymmetric behavior of different RFFE components in the radio frequency paths 225. The UE 115-a may check the network configuration (e.g., RRC configuration) and scheduling to see the carrier or subscription associated with stringent transition cases. In some cases, different radio frequency paths 225 may be associated with different downlink to uplink gaps based on guard symbol and uplink timing advance. The UE 115-a may select the radio frequency path 225-a based on the radio frequency path 225-a being associated with a lesser settling time for a carrier or subscription that is not associated with a guard symbol. In some cases, different radio frequency paths 225 may be associated with different channel transitions and power swing. In some cases, different radio frequency paths 225 may be associated with different quantities of transmission switching or receive switching involved in SRS antenna switching. The UE 115-a may assign the radio frequency path 225 to the subscription or carrier to meet the requirements of the current configuration or scheduling with least impact due to settling or transition times of these RFFE components included in the radio frequency path 225.

In some cases, the UE 115-a may experience co-existence interference between a transmit antenna at the UE 115-a and a receiving antenna at the UE 115-a. The transmit antenna at the UE 115-a may act as an aggressor (e.g., may interfere with the receiving antenna) and de-sense (e.g., interfere) with one or more of the receiving antennas at the UE 115-a. The amount of interference may be a function of a bandwidth and frequency of operation and an operating configuration associated with the transmit antenna and the receiving antenna (e.g., transmit power of the transmit antenna, a received signal strength indicator (RSSI) or reference signal received power (RSRP) of the receiving antenna, RB allocation, or antenna to antenna isolation). The UE 115-a may look at the antenna configurations and perform dynamic path allocation based on co-existence interference to allocate the most efficient pair of radio frequency paths 225 from a co-existence perspective.

In some cases, the UE 115-a may look at the application type (e.g., voice or data) to allocate the radio frequency path 225 that is more suitable for that type of application. For example, a voice call may be sensitive to any kind of noise in the audible region. For example, any circuit noise based on charge or discharge or noise based on other sub systems and relative physical separation from the voice radio associated with the sub systems. The UE 115-a may use the application type information to allocate the voice radio frequency path that may be least impacted by audible noise. Additionally, or alternatively, the same allocation may be used to improve the performance of other subsystem that may be impacted by wireless wide area network (WWAN) operation or noise.

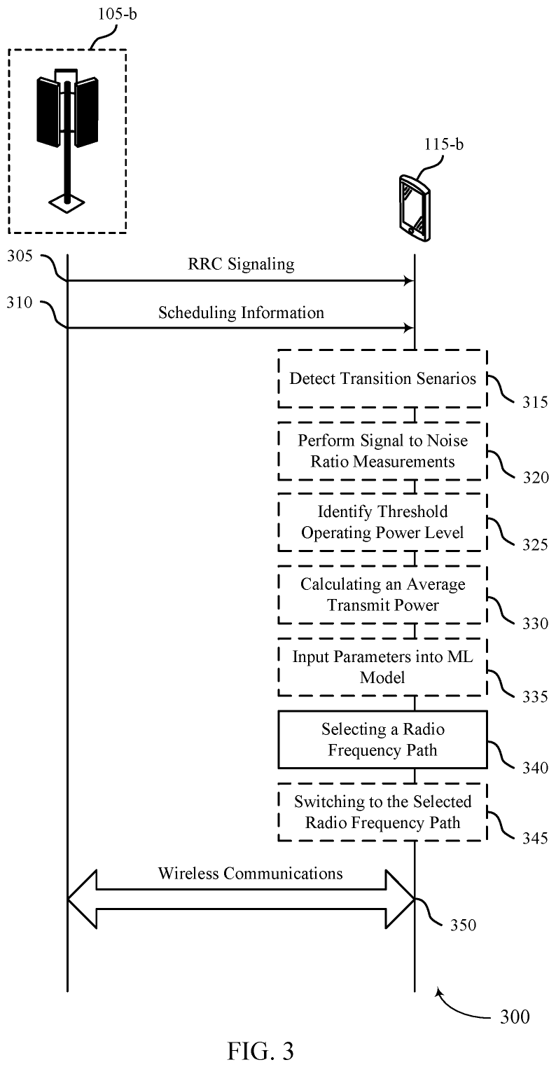

FIG. 3 shows an example of a process flow 300 that supports dynamic resource allocation based on network configuration in accordance with one or more aspects of the present disclosure. In some examples, process flow 300 may implement aspects of, or be implemented by aspects of, the wireless communication system 100 or the wireless communication system 200. For example, the process flow 300 may include a UE 115-b and a network entity 105-b which may be examples of corresponding devices described herein with reference to FIGS. 1 and 2.

At 305, the UE 115-b may receive RRC signaling including a set of parameters for wireless communications with one or more network entities 105 associated with a set of carriers in a carrier aggregation mode, a set of subscriptions at the UE 115-b in a MSIM mode, or both.

At 310, the UE 115-b may receive control signaling including scheduling information (e.g., the dynamic scheduling information as described herein with reference to FIG. 2) for uplink or downlink signaling via the set of carriers, the set of subscriptions, or both.

In some cases, at 315, the UE 115-b may detect one or more transition scenarios pending based on the RRC signaling, the scheduling information for the uplink or downlink signaling, or both. Selecting a first radio frequency path may be based on the one or more transition scenarios. In some cases, the one or more transition scenarios may include a transition between the uplink signaling and the downlink signaling, an antenna switching procedure, a carrier switching procedure, a channel switching procedure, an uplink timing advance, a downlink to uplink gap according to a guard symbol, a power switching procedure, or any combination thereof.

In some cases, at 320, the UE 115-b may perform one or more SNR measurements for the set of carriers or the set of subscriptions. Selecting the first radio frequency path may be based on the one or more SNR measurements, one or more entries in a MCS table indicated by the RRC signaling, a MCS indicated by the control signaling for the uplink signaling, or any combination thereof.

In some cases, a first set of radio frequency components of a first radio frequency path (e.g., a radio frequency path as described herein with reference to FIG. 2) may include a first PA corresponding to a first threshold transmit power for the uplink signaling, and a second set of radio frequency components of a second radio frequency path may include a second PA corresponding to a second threshold transmit power for the uplink signaling.

In some cases, at 325, the UE 115-b may identify a threshold operating power level based on the RRC signaling. At 330, the UE 115-b may calculate an average transmit power based on the control signaling for the uplink signaling. Selecting the first radio frequency path may be based on the threshold operating power level, the average transmit power, or both.

In some cases, the UE 115-b may calculate an average quantity of RBs allocated by the control signaling. Selecting the first radio frequency path may be based on the average quantity of RBs. In some cases, a first set of radio frequency components of the first radio frequency path may include a first PA corresponding to a first threshold efficiency level for the uplink signaling, and a second set of radio frequency components of a second radio frequency path may include a second PA corresponding to a second threshold efficiency level for the uplink signaling.

In some cases, at 335, the UE 115-b may input the set of parameters, the scheduling information, or both, into a ML model associated with the set of radio frequency paths for communicating at the UE. Selecting the first radio frequency path may be based on an output of the ML model.

At 340, the UE 115-b may select the first radio frequency path of a set of radio frequency paths for a carrier of the set of carriers or a subscription of the set of subscriptions based on the set of parameters and the scheduling information. Each radio frequency path of the set of radio frequency paths may correspond to a respective set of radio frequency components. In some cases, selecting the first radio frequency path of the set of radio frequency paths for the carrier of the set of carriers or the subscription of the set of subscriptions may be based on a mobility state at the UE 115-b. In some cases, selecting the first radio frequency path of the set of radio frequency paths for the carrier of the set of carriers or the subscription of the set of subscriptions may be based on co-existence interference associated with a transmit antenna and a receive antenna at the UE 115-b. In some cases, selecting the first radio frequency path of the set of radio frequency paths for the carrier of the plurality of carriers or the subscription of the plurality of subscriptions based on an application type associated with the uplink or downlink signaling. In some cases, selecting the first radio frequency path of the set of radio frequency paths based on an output of the ML model.

At 345, the UE 115-b may switch from a current radio frequency path associated with the carrier of the set of carriers or the subscription of the set of subscriptions to the first radio frequency path based on the selecting. That is, the UE 115-b may switch to the selected radio frequency path. In some cases, the UE 115-b may perform a blanking procedure associated a delay in switching from the current radio frequency path to the first radio frequency path at the UE 115-b.

At 350, the UE 115-b may perform wireless communications according to the selected radio frequency path. For example, the UE 115-a may transmit uplink signaling, or receive downlink signaling (e.g., according to the scheduling information received at 310, the RRC signaling received at 305, or a combination thereof) according to and using the radio frequency path determined at 340.

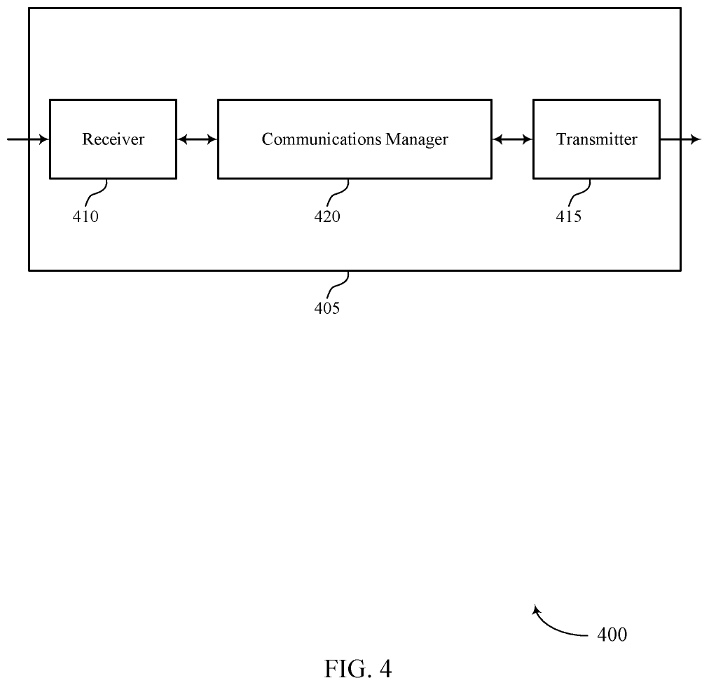

FIG. 4 shows a block diagram 400 of a device 405 that supports dynamic resource allocation based on network configuration in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor (not shown), which may be coupled with at least one memory (not shown), to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to dynamic resource allocation based on network configuration). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to dynamic resource allocation based on network configuration). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of dynamic resource allocation based on network configuration as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for receiving RRC signaling including a set of parameters for wireless communications with one or more network entities associated with a set of multiple carriers in a carrier aggregation mode, a set of multiple subscriptions at the UE in a MSIM mode, or both. The communications manager 420 is capable of, configured to, or operable to support a means for receiving control signaling including scheduling information for uplink or downlink signaling via the set of multiple carriers, the set of multiple subscriptions, or both. The communications manager 420 is capable of, configured to, or operable to support a means for selecting a first radio frequency path of a set of radio frequency paths for a carrier of the set of multiple carriers or a subscription of the set of multiple subscriptions based on the set of parameters and the scheduling information, wherein each radio frequency path of the set of radio frequency paths corresponds to a respective set of radio frequency components.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, more efficient utilization of communication resources, and the like.

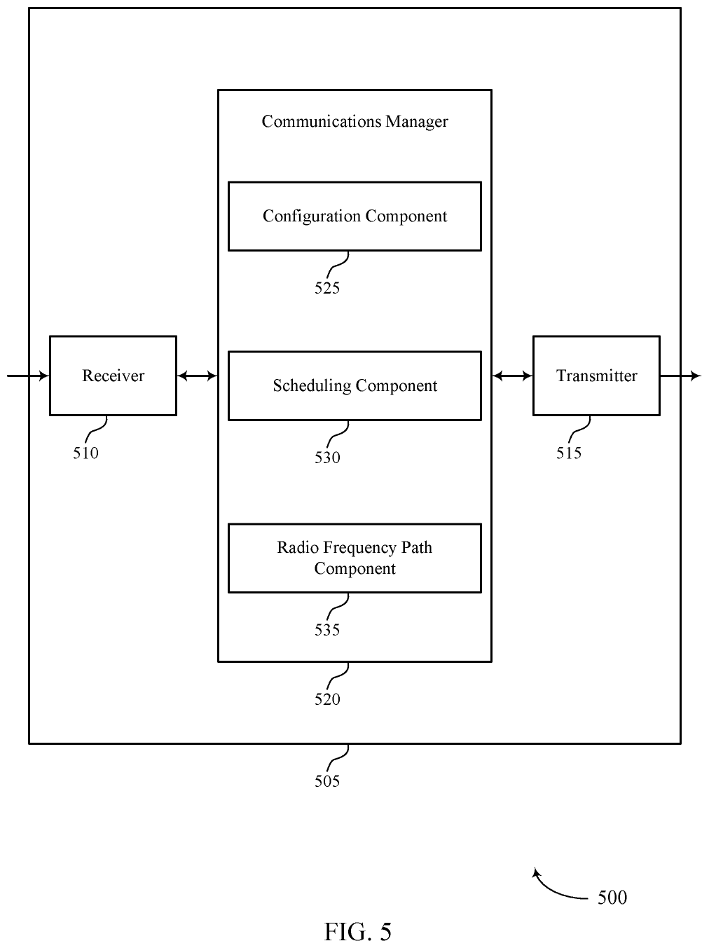

FIG. 5 shows a block diagram 500 of a device 505 that supports dynamic resource allocation based on network configuration in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor (not shown), which may be coupled with at least one memory (not shown), to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to dynamic resource allocation based on network configuration). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to dynamic resource allocation based on network configuration). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of dynamic resource allocation based on network configuration as described herein. For example, the communications manager 520 may include a configuration component 525, a scheduling component 530, a radio frequency path component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The configuration component 525 is capable of, configured to, or operable to support a means for receiving RRC signaling including a set of parameters for wireless communications with one or more network entities associated with a set of multiple carriers in a carrier aggregation mode, a set of multiple subscriptions at the UE in a MSIM mode, or both. The scheduling component 530 is capable of, configured to, or operable to support a means for receiving control signaling including scheduling information for uplink or downlink signaling via the set of multiple carriers, the set of multiple subscriptions, or both. The radio frequency path component 535 is capable of, configured to, or operable to support a means for selecting a first radio frequency path of a set of radio frequency paths for a carrier of the set of multiple carriers or a subscription of the set of multiple subscriptions based on the set of parameters and the scheduling information, wherein each radio frequency path of the set of radio frequency paths corresponds to a respective set of radio frequency components.

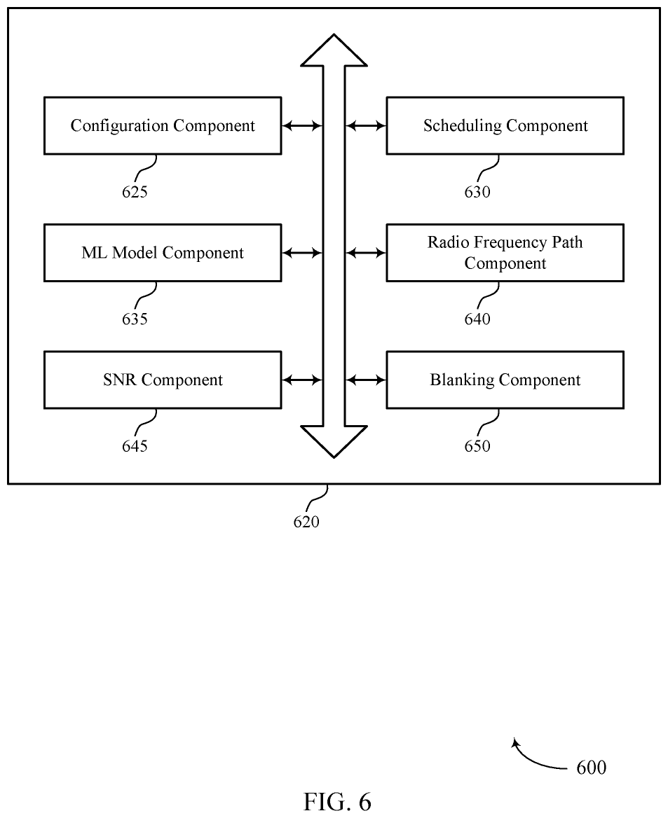

FIG. 6 shows a block diagram 600 of a communications manager 620 that supports dynamic resource allocation based on network configuration in accordance with one or more aspects of the present disclosure. The communications manager 620 may be an example of aspects of a communications manager 420, a communications manager 520, or both, as described herein. The communications manager 620, or various components thereof, may be an example of means for performing various aspects of dynamic resource allocation based on network configuration as described herein. For example, the communications manager 620 may include a configuration component 625, a scheduling component 630, an ML model component 635, a radio frequency path component 640, an SNR component 645, a blanking component 650, or any combination thereof. Each of these components, or components or subcomponents thereof (e.g., one or more processors (not shown), one or more memories (not shown)), may communicate, directly or indirectly, with one another (e.g., via one or more buses).

The configuration component 625 is capable of, configured to, or operable to support a means for receiving RRC signaling including a set of parameters for wireless communications with one or more network entities associated with a set of multiple carriers in a carrier aggregation mode, a set of multiple subscriptions at the UE in a MSIM mode, or both. The scheduling component 630 is capable of, configured to, or operable to support a means for receiving control signaling including scheduling information for uplink or downlink signaling via the set of multiple carriers, the set of multiple subscriptions, or both. The radio frequency path component 640 is capable of, configured to, or operable to support a means for selecting a first radio frequency path of a set of radio frequency paths for a carrier of the set of multiple carriers or a subscription of the set of multiple subscriptions based on the set of parameters and the scheduling information, wherein each radio frequency path of the set of radio frequency paths corresponds to a respective set of radio frequency components.

In some examples, the ML model component 635 is capable of, configured to, or operable to support a means for inputting the set of parameters, the scheduling information, or both, into an ML model associated with the set of radio frequency paths for communicating at the UE, where selecting the first radio frequency path is based on an output of the ML model.

In some examples, the SNR component 645 is capable of, configured to, or operable to support a means for performing one or more SNR measurements for the set of multiple carriers or the set of multiple subscriptions, where selecting the first radio frequency path is based on the one or more SNR measurements, one or more entries in a MCS table indicated by the RRC signaling, a MCS indicated by the control signaling for the uplink signaling, or any combination thereof.

In some examples, a first set of radio frequency components of the first radio frequency path includes a first PA corresponding to a first threshold transmit power for the uplink signaling. In some examples, a second set of radio frequency components of a second radio frequency path includes a second PA corresponding to a second threshold transmit power for the uplink signaling.

In some examples, the configuration component 625 is capable of, configured to, or operable to support a means for identifying a threshold operating power level based on the RRC signaling. In some examples, the ML model component 635 is capable of, configured to, or operable to support a means for calculating an average transmit power based on the control signaling for the uplink signaling, where selecting the first radio frequency path is based at least in part on the threshold operating power level, the average transmit power, or both.

In some examples, the scheduling component 630 is capable of, configured to, or operable to support a means for calculating an average quantity of RBs allocated by the control signaling, where selecting the first radio frequency path is based on the average quantity of RBs, and where a first set of radio frequency components of the first radio frequency path includes a first PA corresponding to a first threshold efficiency level for the uplink signaling, and where a second set of radio frequency components of a second radio frequency path includes a second PA corresponding to a second threshold efficiency level for the uplink signaling.

In some examples, the ML model component 635 is capable of, configured to, or operable to support a means for detecting one or more transition scenarios pending based on the RRC signaling, the scheduling information for the uplink or downlink signaling, or both, where selecting the first radio frequency path is based on the one or more transition scenarios.

In some examples, the one or more transition scenarios include a transition between the uplink signaling and the downlink signaling, an antenna switching procedure, a carrier switching procedure, a channel switching procedure, an uplink timing advance, a downlink to uplink gap according to a guard symbol, a power switching procedure, or any combination thereof.

In some examples, to support selecting the first radio frequency path, the radio frequency path component 640 is capable of, configured to, or operable to support a means for selecting the first radio frequency path of the set of radio frequency paths for the carrier of the set of multiple carriers or the subscription of the set of multiple subscriptions based on a mobility state at the UE.

In some examples, to support selecting the first radio frequency path, the radio frequency path component 640 is capable of, configured to, or operable to support a means for selecting the first radio frequency path of the set of radio frequency paths for the carrier of the plurality of carriers or the subscription of the plurality of subscriptions is based on co-existence interference associated with a transmit antenna and a receive antenna at the UE.

In some examples, to support selecting the first radio frequency path, the radio frequency path component 640 is capable of, configured to, or operable to support a means for selecting the first radio frequency path of the set of radio frequency paths for the carrier of the plurality of carriers or the subscription of the plurality of subscriptions based at least in part on an application type associated with the uplink or downlink signaling.

In some examples, the radio frequency path component 640 is capable of, configured to, or operable to support a means for switching from a current radio frequency path associated with the carrier of the set of multiple carriers or the subscription of the set of multiple subscriptions to the first radio frequency path based on the selecting.

In some examples, the blanking component 650 is capable of, configured to, or operable to support a means for performing a blanking procedure associated a delay in switching from the current radio frequency path to the first radio frequency path at the UE.

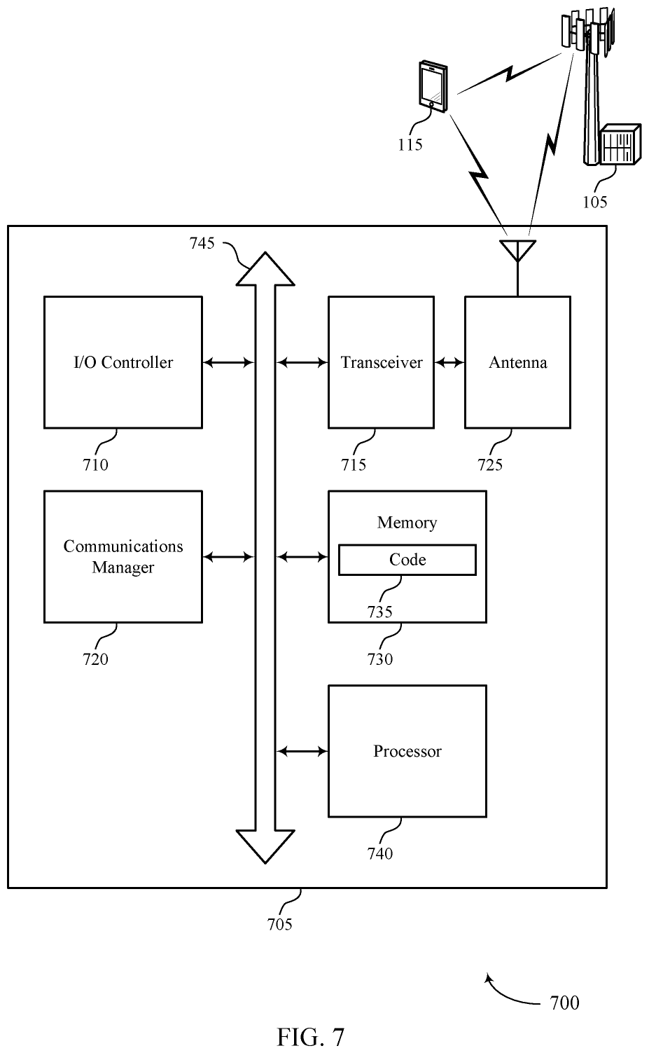

FIG. 7 shows a diagram of a system 700 including a device 705 that supports dynamic resource allocation based on network configuration in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting dynamic resource allocation based on network configuration). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

For example, the communications manager 720 is capable of, configured to, or operable to support a means for receiving RRC signaling including a set of parameters for wireless communications with one or more network entities associated with a set of multiple carriers in a carrier aggregation mode, a set of multiple subscriptions at the UE in a MSIM mode, or both. The communications manager 720 is capable of, configured to, or operable to support a means for receiving control signaling including scheduling information for uplink or downlink signaling via the set of multiple carriers, the set of multiple subscriptions, or both. The communications manager 720 is capable of, configured to, or operable to support a means for selecting a first radio frequency path of a set of radio frequency paths for a carrier of the set of multiple carriers or a subscription of the set of multiple subscriptions based on the set of parameters and the scheduling information, wherein each radio frequency path of the set of radio frequency paths corresponds to a respective set of radio frequency components.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described herein with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of dynamic resource allocation based on network configuration as described herein, or the at least one processor 740 and the at least one memory 730 may be otherwise configured to, individually or collectively, perform or support such operations.

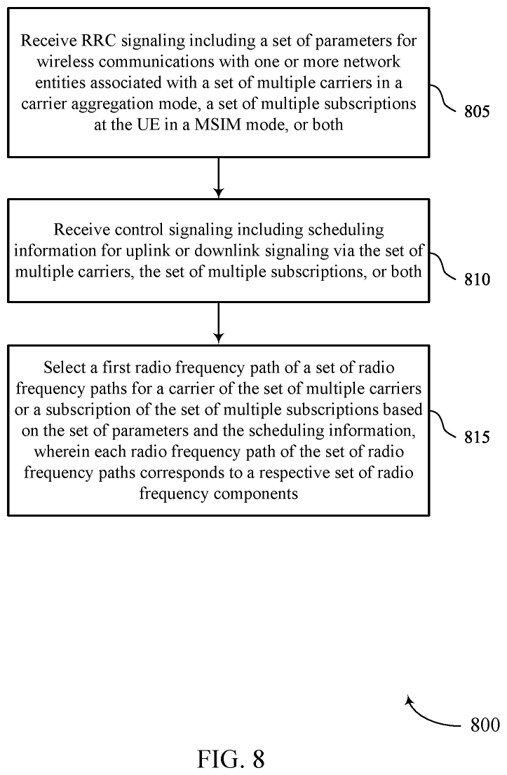

FIG. 8 shows a flowchart illustrating a method 800 that supports dynamic resource allocation based on network configuration in accordance with one or more aspects of the present disclosure. The operations of the method 800 may be implemented by a UE or its components as described herein. For example, the operations of the method 800 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving RRC signaling including a set of parameters for wireless communications with one or more network entities associated with a set of multiple carriers in a carrier aggregation mode, a set of multiple subscriptions at the UE in a MSIM mode, or both. The operations of 805 may be performed in accordance with examples as disclosed herein. In some examples, aspects of the operations of 805 may be performed by a configuration component 625 as described herein with reference to FIG. 6.

At 810, the method may include receiving control signaling including scheduling information for uplink or downlink signaling via the set of multiple carriers, the set of multiple subscriptions, or both. The operations of 810 may be performed in accordance with examples as disclosed herein. In some examples, aspects of the operations of 810 may be performed by a scheduling component 630 as described herein with reference to FIG. 6.

At 815, the method may include selecting a first radio frequency path of a set of radio frequency paths for a carrier of the set of multiple carriers or a subscription of the set of multiple subscriptions based on the set of parameters and the scheduling information, wherein each radio frequency path of the set of radio frequency paths corresponds to a respective set of radio frequency components. The operations of 815 may be performed in accordance with examples as disclosed herein. In some examples, aspects of the operations of 815 may be performed by a radio frequency path component 640 as described herein with reference to FIG. 6.

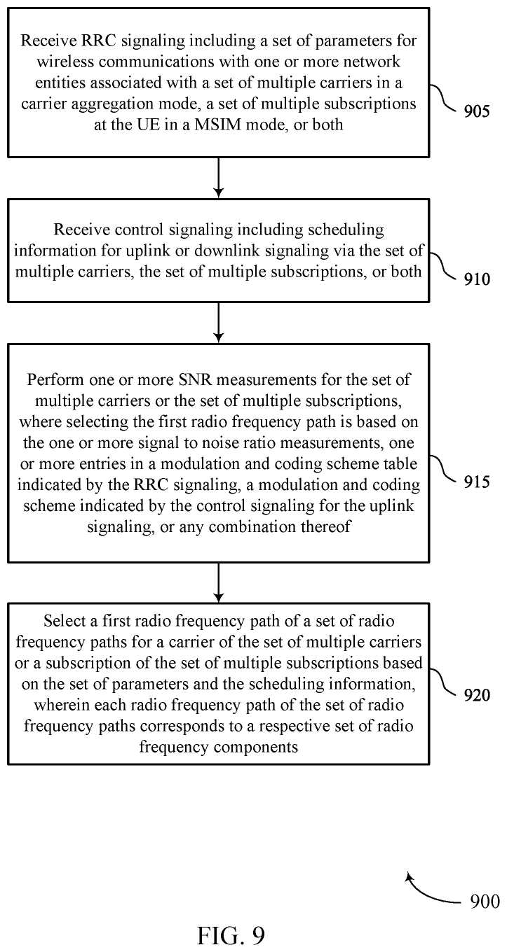

FIG. 9 shows a flowchart illustrating a method 900 that supports dynamic resource allocation based on network configuration in accordance with one or more aspects of the present disclosure. The operations of the method 900 may be implemented by a UE or its components as described herein. For example, the operations of the method 900 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving RRC signaling including a set of parameters for wireless communications with one or more network entities associated with a set of multiple carriers in a carrier aggregation mode, a set of multiple subscriptions at the UE in a MSIM mode, or both. The operations of 905 may be performed in accordance with examples as disclosed herein. In some examples, aspects of the operations of 905 may be performed by a configuration component 625 as described herein with reference to FIG. 6.

At 910, the method may include receiving control signaling including scheduling information for uplink or downlink signaling via the set of multiple carriers, the set of multiple subscriptions, or both. The operations of 910 may be performed in accordance with examples as disclosed herein. In some examples, aspects of the operations of 910 may be performed by a scheduling component 630 as described herein with reference to FIG. 6.

At 915, the method may include performing one or more SNR measurements for the set of multiple carriers or the set of multiple subscriptions, where selecting the first radio frequency path is based on the one or more SNR measurements, one or more entries in a MCS table indicated by the RRC signaling, a MCS indicated by the control signaling for the uplink signaling, or any combination thereof. The operations of 915 may be performed in accordance with examples as disclosed herein. In some examples, aspects of the operations of 915 may be performed by an SNR component 645 as described herein with reference to FIG. 6.

At 920, the method may include selecting a first radio frequency path of a set of radio frequency paths for a carrier of the set of multiple carriers or a subscription of the set of multiple subscriptions based on the set of parameters and the scheduling information, wherein each radio frequency path of the set of radio frequency paths corresponds to a respective set of radio frequency components. The operations of 920 may be performed in accordance with examples as disclosed herein. In some examples, aspects of the operations of 920 may be performed by a radio frequency path component 640 as described herein with reference to FIG. 6.

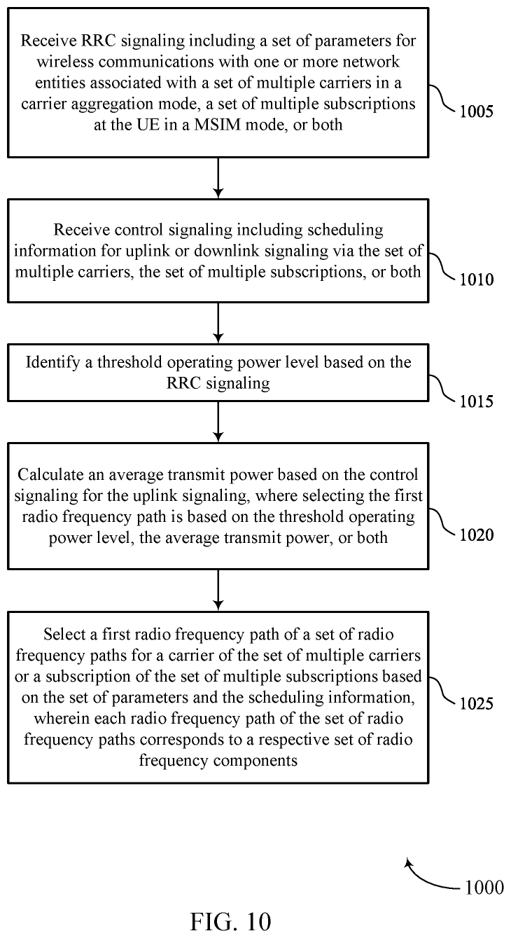

FIG. 10 shows a flowchart illustrating a method 1000 that supports dynamic resource allocation based on network configuration in accordance with one or more aspects of the present disclosure. The operations of the method 1000 may be implemented by a UE or its components as described herein. For example, the operations of the method 1000 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving RRC signaling including a set of parameters for wireless communications with one or more network entities associated with a set of multiple carriers in a carrier aggregation mode, a set of multiple subscriptions at the UE in a MSIM mode, or both. The operations of 1005 may be performed in accordance with examples as disclosed herein. In some examples, aspects of the operations of 1005 may be performed by a configuration component 625 as described herein with reference to FIG. 6.

At 1010, the method may include receiving control signaling including scheduling information for uplink or downlink signaling via the set of multiple carriers, the set of multiple subscriptions, or both. The operations of 1010 may be performed in accordance with examples as disclosed herein. In some examples, aspects of the operations of 1010 may be performed by a scheduling component 630 as described herein with reference to FIG. 6.

At 1015, the method may include identifying a threshold operating power level based on the RRC signaling. The operations of 1015 may be performed in accordance with examples as disclosed herein. In some examples, aspects of the operations of 1015 may be performed by a configuration component 625 as described herein with reference to FIG. 6.

At 1020, the method may include calculating an average transmit power based on the control signaling for the uplink signaling, where selecting the first radio frequency path is based on the threshold operating power level, the average transmit power, or both. The operations of 1020 may be performed in accordance with examples as disclosed herein. In some examples, aspects of the operations of 1020 may be performed by an ML model component 635 as described herein with reference to FIG. 6.

At 1025, the method may include selecting a first radio frequency path of a set of radio frequency paths for a carrier of the set of multiple carriers or a subscription of the set of multiple subscriptions based on the set of parameters and the scheduling information, wherein each radio frequency path of the set of radio frequency paths corresponds to a respective set of radio frequency components. The operations of 1025 may be performed in accordance with examples as disclosed herein. In some examples, aspects of the operations of 1025 may be performed by a radio frequency path component 640 as described herein with reference to FIG. 6.

The following provides an overview of aspects of the present disclosure:

Aspect 1: A method for wireless communications at a UE, comprising: receiving RRC signaling comprising a set of parameters for wireless communications with one or more network entities associated with a plurality of carriers in a carrier aggregation mode, a plurality of subscriptions at the UE in a MSIM mode, or both; receiving control signaling comprising scheduling information for uplink or downlink signaling via the plurality of carriers, the plurality of subscriptions, or both; and selecting a first radio frequency path of a set of radio frequency paths for a carrier of the plurality of carriers or a subscription of the plurality of subscriptions based at least in part on the set of parameters and the scheduling information, wherein each radio frequency path of the set of radio frequency paths corresponds to a respective set of radio frequency components.

Aspect 2: The method of aspect 1, further comprising: performing one or more SNR measurements for the plurality of carriers or the plurality of subscriptions, wherein selecting the first radio frequency path is based at least in part on the one or more SNR measurements, one or more entries in a MCS table indicated by the RRC signaling, a MCS indicated by the control signaling for the uplink signaling, or any combination thereof.

Aspect 3: The method of aspect 2, wherein a first set of radio frequency components of the first radio frequency path comprises a first PA corresponding to a first threshold transmit power for the uplink signaling, and a second set of radio frequency components of a second radio frequency path comprises a second PA corresponding to a second threshold transmit power for the uplink signaling.

Aspect 4: The method of any of aspects 1 through 3, further comprising: identifying a threshold operating power level based at least in part on the RRC signaling; and calculating an average transmit power based at least in part on the control signaling for the uplink signaling, wherein selecting the first radio frequency path is based at least in part on the threshold operating power level, the average transmit power, or both.

Aspect 5: The method of aspect 4, further comprising: calculating an average quantity of RBs allocated by the control signaling, wherein selecting the first radio frequency path is based at least in part on the average quantity of RBs, and wherein a first set of radio frequency components of the first radio frequency path comprises a first PA corresponding to a first threshold efficiency level for the uplink signaling, and wherein a second set of radio frequency components of a second radio frequency path comprises a second PA corresponding to a second threshold efficiency level for the uplink signaling.

Aspect 6: The method of any of aspects 1 through 5, further comprising: detecting one or more transition scenarios pending based at least in part on the RRC signaling, the scheduling information for the uplink or downlink signaling, or both, wherein selecting the first radio frequency path is based at least in part on the one or more transition scenarios.

Aspect 7: The method of aspect 6, wherein the one or more transition scenarios comprise a transition between the uplink signaling and the downlink signaling, an antenna switching procedure, a carrier switching procedure, a channel switching procedure, an uplink timing advance, a downlink to uplink gap according to a guard symbol, a power switching procedure, or any combination thereof.

Aspect 8: The method of any of aspects 1 through 7, wherein to selecting the first radio frequency path further comprises: selecting the first radio frequency path of the set of radio frequency paths for the carrier of the plurality of carriers or the subscription of the plurality of subscriptions based at least in part on a mobility state at the UE.

Aspect 9: The method of any of aspects 1 through 8, further comprising: switching from a current radio frequency path associated with the carrier of the plurality of carriers or the subscription of the plurality of subscriptions to the first radio frequency path based at least in part on the selecting.

Aspect 10: The method of aspect 9, further comprising: performing a blanking procedure associated a delay in switching from the current radio frequency path to the first radio frequency path at the UE.

Aspect 11: The method of any of aspects 1 through 10, further comprising: inputting the set of parameters, the scheduling information, or both, into a ML model associated with the set of radio frequency paths for communicating at the UE, wherein selecting the first radio frequency path is based at least in part on an output of the ML model.

Aspect 12: The method of any of aspects 1 through 11, wherein selecting the first radio frequency path of the set of radio frequency paths for the carrier of the plurality of carriers or the subscription of the plurality of subscriptions is based at least in part on co-existence interference associated with a transmit antenna and a receive antenna at the UE.

Aspect 13: The method of any of aspects 1 through 12, wherein selecting the first radio frequency path of the set of radio frequency paths for the carrier of the plurality of carriers or the subscription of the plurality of subscriptions based at least in part on an application type associated with the uplink or downlink signaling.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An user equipment (UE), comprising:
one or more memories storing processor-executable code; and
one or more processors coupled with the one or more memories and individually or collectively operable to execute the code to cause the UE to:
receive radio resource control (RRC) signaling comprising a set of parameters for wireless communications with one or more network entities associated with a plurality of carriers in a carrier aggregation mode, a plurality of subscriptions at the UE in a multi-subscriber identify module (MSIM) mode, or both;
receive control signaling comprising scheduling information for uplink or downlink signaling via the plurality of carriers, the plurality of subscriptions, or both; and
select a first radio frequency path of a set of radio frequency paths for a carrier of the plurality of carriers or a subscription of the plurality of subscriptions based at least in part on the set of parameters and the scheduling information, wherein each radio frequency path of the set of radio frequency paths corresponds to a respective set of radio frequency components.

2. The UE of claim 1, wherein the one or more processors are individually or collectively further operable to execute the code to cause the UE to:
perform one or more signal to noise ratio measurements for the plurality of carriers or the plurality of subscriptions, wherein selecting the first radio frequency path is based at least in part on the one or more signal to noise ratio measurements, one or more entries in a modulation and coding scheme table indicated by the RRC signaling, a modulation and coding scheme indicated by the control signaling for the uplink signaling, or any combination thereof.

3. The UE of claim 2, wherein:
a first set of radio frequency components of the first radio frequency path comprises a first power amplifier corresponding to a first threshold transmit power for the uplink signaling, and
a second set of radio frequency components of a second radio frequency path comprises a second power amplifier corresponding to a second threshold transmit power for the uplink signaling.

4. The UE of claim 1, wherein the one or more processors are individually or collectively further operable to execute the code to cause the UE to:
identify a threshold operating power level based at least in part on the RRC signaling; and
calculate an average transmit power based at least in part on the control signaling for the uplink signaling, wherein selecting the first radio frequency path is based at least in part on the threshold operating power level, the average transmit power, or both.

5. The UE of claim 4, wherein the one or more processors are individually or collectively further operable to execute the code to cause the UE to:
calculate an average quantity of resource blocks allocated by the control signaling, wherein selecting the first radio frequency path is based at least in part on the average quantity of resource blocks, and wherein a first set of radio frequency components of the first radio frequency path comprises a first power amplifier corresponding to a first threshold efficiency level for the uplink signaling, and wherein a second set of radio frequency components of a second radio frequency path comprises a second power amplifier corresponding to a second threshold efficiency level for the uplink signaling.

6. The UE of claim 1, wherein the one or more processors are individually or collectively further operable to execute the code to cause the UE to:
detect one or more transition scenarios pending based at least in part on the RRC signaling, the scheduling information for the uplink or downlink signaling, or both, wherein selecting the first radio frequency path is based at least in part on the one or more transition scenarios.

7. The UE of claim 6, wherein the one or more transition scenarios comprise a transition between the uplink signaling and the downlink signaling, an antenna switching procedure, a carrier switching procedure, a channel switching procedure, an uplink timing advance, a downlink to uplink gap according to a guard symbol, a power switching procedure, or any combination thereof.

8. The UE of claim 1, wherein, to select the first radio frequency path, the one or more processors are individually or collectively further operable to execute the code to cause the UE to:
select the first radio frequency path of the set of radio frequency paths for the carrier of the plurality of carriers or the subscription of the plurality of subscriptions based at least in part on a mobility state at the UE.

9. The UE of claim 1, wherein the one or more processors are individually or collectively further operable to execute the code to cause the UE to:
switch from a current radio frequency path associated with the carrier of the plurality of carriers or the subscription of the plurality of subscriptions to the first radio frequency path based at least in part on the selecting.

10. The UE of claim 9, wherein the one or more processors are individually or collectively further operable to execute the code to cause the UE to:
perform a blanking procedure associated a delay in switching from the current radio frequency path to the first radio frequency path at the UE.

11. The UE of claim 1, wherein the one or more processors are individually or collectively further operable to execute the code to cause the UE to:
input the set of parameters, the scheduling information, or both, into a machine learning model associated with the set of radio frequency paths for communicating at the UE, wherein selecting the first radio frequency path is based at least in part on an output of the machine learning model.

12. The UE of claim 1, wherein, selecting the first radio frequency path of the set of radio frequency paths for the carrier of the plurality of carriers or the subscription of the plurality of subscriptions is based at least in part on co-existence interference associated with a transmit antenna and a receive antenna at the UE.

13. The UE of claim 1, wherein, selecting the first radio frequency path of the set of radio frequency paths for the carrier of the plurality of carriers or the subscription of the plurality of subscriptions based at least in part on an application type associated with the uplink or downlink signaling.

14. A method, at a user equipment (UE) comprising:
receiving radio resource control (RRC) signaling comprising a set of parameters for wireless communications with one or more network entities associated with a plurality of carriers in a carrier aggregation mode, a plurality of subscriptions at the UE in a multi-subscriber identify module (MSIM) mode, or both;
receiving control signaling comprising scheduling information for uplink or downlink signaling via the plurality of carriers, the plurality of subscriptions, or both; and
selecting a first radio frequency path of a set of radio frequency paths for a carrier of the plurality of carriers or a subscription of the plurality of subscriptions based at least in part on the set of parameters and the scheduling information, wherein each radio frequency path of the set of radio frequency paths corresponds to a respective set of radio frequency components.

15. The method of claim 14, further comprising:
performing one or more signal to noise ratio measurements for the plurality of carriers or the plurality of subscriptions, wherein selecting the first radio frequency path is based at least in part on the one or more signal to noise ratio measurements, one or more entries in a modulation and coding scheme table indicated by the RRC signaling, a modulation and coding scheme indicated by the control signaling for the uplink signaling, or any combination thereof.

16. The method of claim 15, wherein:
a first set of radio frequency components of the first radio frequency path comprises a first power amplifier corresponding to a first threshold transmit power for the uplink signaling, and
a second set of radio frequency components of a second radio frequency path comprises a second power amplifier corresponding to a second threshold transmit power for the uplink signaling.

17. The method of claim 14, further comprising:
identifying a threshold operating power level based at least in part on the RRC signaling; and
calculating an average transmit power based at least in part on the control signaling for the uplink signaling, wherein selecting the first radio frequency path is based at least in part on the threshold operating power level, the average transmit power, or both.

18. The method of claim 17, further comprising:
calculating an average quantity of resource blocks allocated by the control signaling, wherein selecting the first radio frequency path is based at least in part on the average quantity of resource blocks, and wherein a first set of radio frequency components of the first radio frequency path comprises a first power amplifier corresponding to a first threshold efficiency level for the uplink signaling, and wherein a second set of radio frequency components of a second radio frequency path comprises a second power amplifier corresponding to a second threshold efficiency level for the uplink signaling.

19. The method of claim 14, further comprising:
detecting one or more transition scenarios pending based at least in part on the RRC signaling, the scheduling information for the uplink or downlink signaling, or both, wherein selecting the first radio frequency path is based at least in part on the one or more transition scenarios.

20. A non-transitory computer-readable medium storing code, the code comprising instructions executable by one or more processors to:
receive radio resource control (RRC) signaling comprising a set of parameters for wireless communications with one or more network entities associated with a plurality of carriers in a carrier aggregation mode, a plurality of subscriptions at a UE in a multi-subscriber identify module (MSIM) mode, or both;
receive control signaling comprising scheduling information for uplink or downlink signaling via the plurality of carriers, the plurality of subscriptions, or both; and
select a first radio frequency path of a set of radio frequency paths for a carrier of the plurality of carriers or a subscription of the plurality of subscriptions based at least in part on the set of parameters and the scheduling information, wherein each radio frequency path of the set of radio frequency paths corresponds to a respective set of radio frequency components.
